(19) United States
(12) Patent Application Publication
(10) Pub. No.: US 2003/0046524 A1
(43) Pub. Date: Mar. 6, 2003

(54) Method for dynamically designating initialization modules as recovery code

(76) Inventors: Vincent J. Zimmer, Federal Way, WA (US); John P. Lambino, Beaverton, OR (US); Andrew J. Fish, Olympia, WA (US); Shaofan Li, Shanghai (CN); Sham M. Datta, Hillsboro, OR (US); William A. Stevens, Folsom, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/943,904

(22) Filed: Aug. 30, 2001

(51) Int. Cl. G06F 15/177

(52) U.S. Cl. 713/1

(57) ABSTRACT

A method and apparatus for the dynamic inclusion or exclusion of initialization modules within the set of initialization modules designated as recovery initialization modules is described. When a BIOS system is updated through the inclusion of a new initialization module, the algorithm of the present invention dynamically determines if the initialization module is required for recovery. A firmware update utility evaluates new initiation modules to determine if they are designated as recovery or required by core recovery modules. If so, the new module is designated for recovery and stored to a fault-tolerant block within a recovery file volume. The firmware update utility of the present invention allows an initiation module to be automatically designated as recovery only when necessary. Initiation modules, designated as recovery, that subsequently are not required fro recovery may be omitted from the recovery set. Thus the collection of recovery initiation modules is minimized.

### FIELD OF THE INVENTION

This invention relates generally to the basic input/output system (BIOS) of a computer system, and more specifically to the designation of recovery code in a computer system having a component firmware architecture.

### BACKGROUND OF THE INVENTION

Recovery code is a typically small subset of the BIOS code that allows the system access through an input/output (I/O) device to provide minimal initialization in the event of corruption (e.g., hardware failure, security error, etc.) to effect the restoration of the entire firmware image. That is, the system is able to boot to a point so that a copy of lost data can be read from a specified peripheral. Typically what a BIOS vendor does is to designate a portion of the BIOS firmware as recovery and protect that code. The rest of the BIOS would be designated as non-recovery and would not be protected. The recovery/non-recovery designation is static. Therefore, in the event of a bug fix or a new feature the entire BIOS must be changed, or at least the entire recovery block.

A recent development in computer system firmware is an extensible firmware interface framework that allows software vendors to develop operating systems programs that can be used with a variety of central processing units (CPUs).

Componentization of the BIOS presents the issue of evolving recovery code. In a component-based firmware file system, one or more firmware volumes may contain recovery initialization modules (RIMs). Initially the system vendor may aggregate initialization modules from multiple parties and designate those initialization modules necessary for recovery. The RIMs are kept in a fault-tolerant block, the size of which is determined by the system manufacturer. Typically, this fault-tolerant block may be 64 kilobytes in size. The number of initialization modules designated as RIMs is typically kept to a minimum because RIMs must be rendered fault tolerant, which is expensive. During the life of the system, the consumer may wish to update the firmware by replacing/adding initialization modules. These modules may not have been designated as a RIM at the time of design, but a subset of the RIMs may depend on the module. Therefore, if corruption occurs, a full recovery may not be possible. For example, the added initialization module may be responsible for initializing memory. Since the added module was not rendered fault tolerant by inclusion in the recovery set, the system may not have the necessary component to initialize the memory controller.

An exemplary recovery procedure for a computing system having component firmware architecture is described as follows. The dispatcher is notified to transition to recovery mode by the setting of a particular bit, i.e. a “” bit. The dispatcher clears out the fault tolerant by inclusion in the recovery set, the system may not have the necessary component to initialize the memory controller. An exemplary recovery list of initiation modules dispatched and sets the pass state to Pass 1. The dispatcher then sets the Boot_in_Recovery_Mask. Typically, a reset is issued at this point to reset hardware back to a pristine state. The current boot path needs to be saved in an area that is unaffected by a reset and restored after the reset. The dispatcher then restarts the dispatch in recovery mode. IMs that require different actions in “Recovery” mode than normal mode and IMs known to be required for “Recovery” mode need to be designated as such. For example by setting a recovery bit in the IMs FFS header. These modules along with the security startup code and the initialization core make up the recovery block.

The dispatcher commences searching for modules to invoke and only invokes those modules that are actually marked as being for “recovery dispatch” in the course of its search. These modules might also serve dual purpose for the normal boot, such as having just one IM for memory initialization, but when these modules detect that the boot in recovery bit is set, they should only perform the minimal behavior. The intent of the platform specific IMs is to alert the initiation core of the recovery condition and to also initialize enough of the platform I/O complex and memory for recovery. The modules marked “recovery dispatch” can have Interface Import Table references to non-recovery IMs. These referenced non-recovery IMs need to be stored in the boot block to insure all required modules are in a secure non-corruptible area. This implies that during a normal update an IM newly referenced by recovery code, and that is in a non-boot block area, should be migrated to the boot block.

FIG. 1 is a platform module dispatch for such a recovery process. Process 100, shown in FIG. 1 begins with operation 105 in which the core is initialized. In operations 110 and 115, all IMs marked for recovery will be executed and then the driver execution initial program loader (IPL) will be executed at operation 120.

If the boot mode is not equal to recovery, then subsequent IMs are executed at operation 125, and after each a determination is made as to whether the returned boot mode is equal to recovery. If not, no recovery is required and the driver execution IPL is executed. If a recovery is necessary, the boot mode is set to recovery and the boot mode is saved in non-volatile storage at operation 130. From there the system is reset at operation 135 and the core is initialized in recovery mode at operation 140.

### BRIEF DESCRIPTION OF THE DRAWINGS

The present invention is illustrated by way of example and not intended to be limited by the figures of the accompanying drawings in which like references indicate similar elements and in which:

FIG. 1 is a platform module dispatch for such a recovery process;

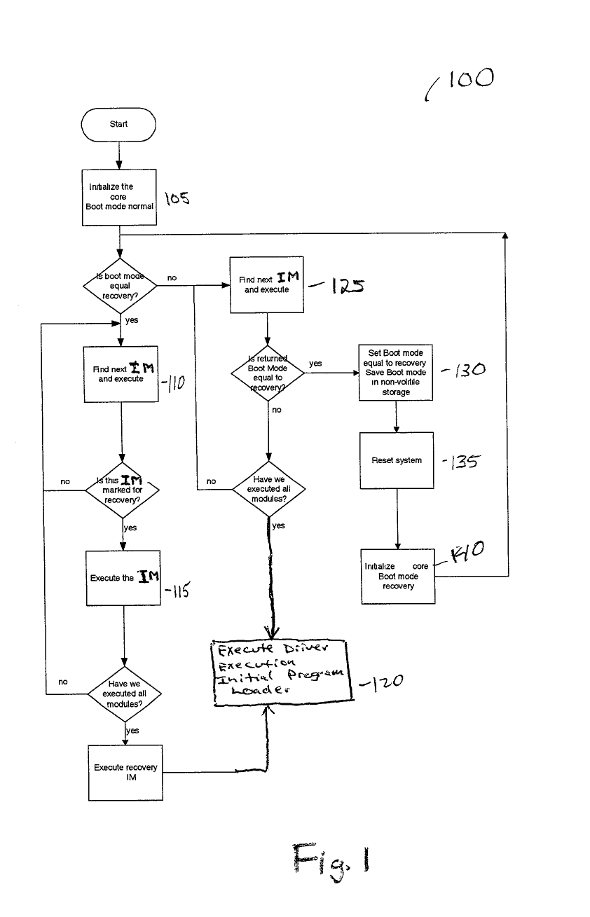

FIG. 2 is a diagram illustrating an exemplary computing system 200 for implementing the present invention;

FIG. 3 is a process flow diagram in accordance with the present invention; and

FIGS. 4A, 4B, and 4C depict a firmware volume update in accordance with the present invention.

### DETAILED DESCRIPTION

The method and apparatus described herein may be used for the dynamic inclusion or exclusion of initialization modules within the set of initialization modules designated recovery initialization modules. In one embodiment the BIOS system of a computing system, having a component firmware architecture (i.e., componentized BIOS), is updated through the inclusion of a new initialization module (IM). The new IM is evaluated to determine if it is designated as recovery. If so, the new module is tagged as being necessary for recovery and stored to the recovery block, a fault tolerant block within a file volume. In an alternative embodiment, all of the IMs currently designated as recovery IMs (RIMs) are evaluated to determine if a dependency upon the new IM exists. If any RIM is dependent upon the new IM, the new IM is tagged as a graduate to recovery. Under conditions of recovery restart the firmware will only execute those modules that are marked for recovery or have been graduated to recovery.

The present invention allows an IM to be designated as being required for recovery only when necessary. It does not encumber the collection of recovery IM's to be large when not required by associated dependency tables. The present invention provides the ability to make an automatic real-time determination of whether or not an IM is required for recovery.

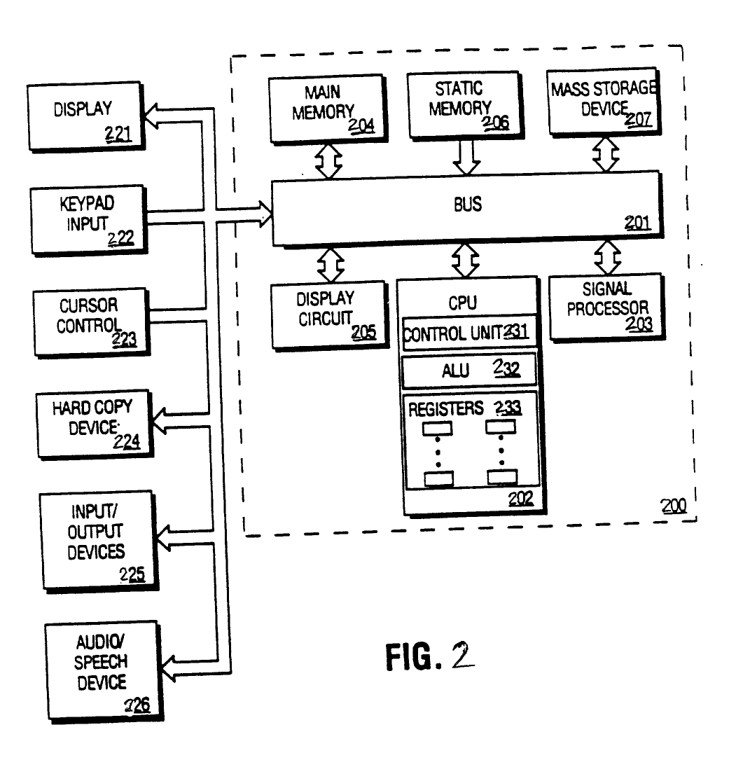

FIG. 2 is a diagram illustrating an exemplary computing system 200 for implementing the recovery set inclusion/exclusion process of the present invention. The method of dynamic designation of initialization modules as being necessary for recovery described herein can be implemented and utilized within computing system 200, which can represent a general-purpose computer, portable computer, or other like device. The components of computing system 200 are exemplary in which one or more components can be omitted or added. For example, one or more memory devices can be utilized for computing system 200.

Referring to FIG. 2, computing system 200 includes a central processing unit 202 and a signal processor 203 coupled to a display circuit 205, main memory 204, static memory 206, and mass storage device 207 via bus 201. Computing system 200 can also be coupled to a display 221, keypad input 222, cursor control 223, hard copy device 224, input/output (I/O) devices 225, and audio/speech device 226 via bus 201.

Bus 201 is a standard system bus for communicating information and signals. CPU 202 and signal processor 203 are processing units for computing system 200. CPU 202 or signal processor 203 or both can be used to process information and/or signals for computing system 200. CPU 202 includes a control unit 231, an arithmetic logic unit (ALU) 232, and several registers 233, which are used to process information and signals. Signal processor 203 can also include similar components as CPU 202.

Main memory 204 can be, e.g., a random access memory (RAM) or some other dynamic storage device, for storing information or instructions (program code), which are used by CPU 202 or signal processor 203. Main memory 204 may store temporary variables or other intermediate information during execution of instructions by CPU 202 or signal processor 203. Static memory 206 can be, e.g., a read only memory (ROM) and/or other static storage devices, for storing system firmware or other information or instructions, which can also be used by CPU 202 or signal processor 203. Mass storage device 207 can be, e.g., a hard or floppy disk drive or optical disk drive, for storing information or instructions for computing system 200.

Display 221 can be, e.g., a cathode ray tube (CRT) or liquid crystal display (LCD). Display device 221 displays information or graphics to a user. Computing system 200 can interface with display 221 via display circuit 205. Keypad input 222 is an alphanumeric input device with an analog to digital converter. Cursor control 223 can be, e.g., a mouse, a trackball, or cursor direction keys, for controlling movement of an object on display 221. Hard copy device 224 can be, e.g., a laser printer, for printing information on paper, film, or some other like medium. A number of input/output devices 225 can be coupled to computing system 200. The dynamic determination to include or exclude IMs within the set of RIMs in accordance with the present invention can be implemented by hardware and/or software contained within computing system 200. For example, CPU 202 or signal processor 203 can execute code or instructions stored in a machine-readable medium, e.g., main memory 204. The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, flash memory devices. The code or instructions may be represented by carrier-wave signals, infrared signals, digital signals, and by other like signals.

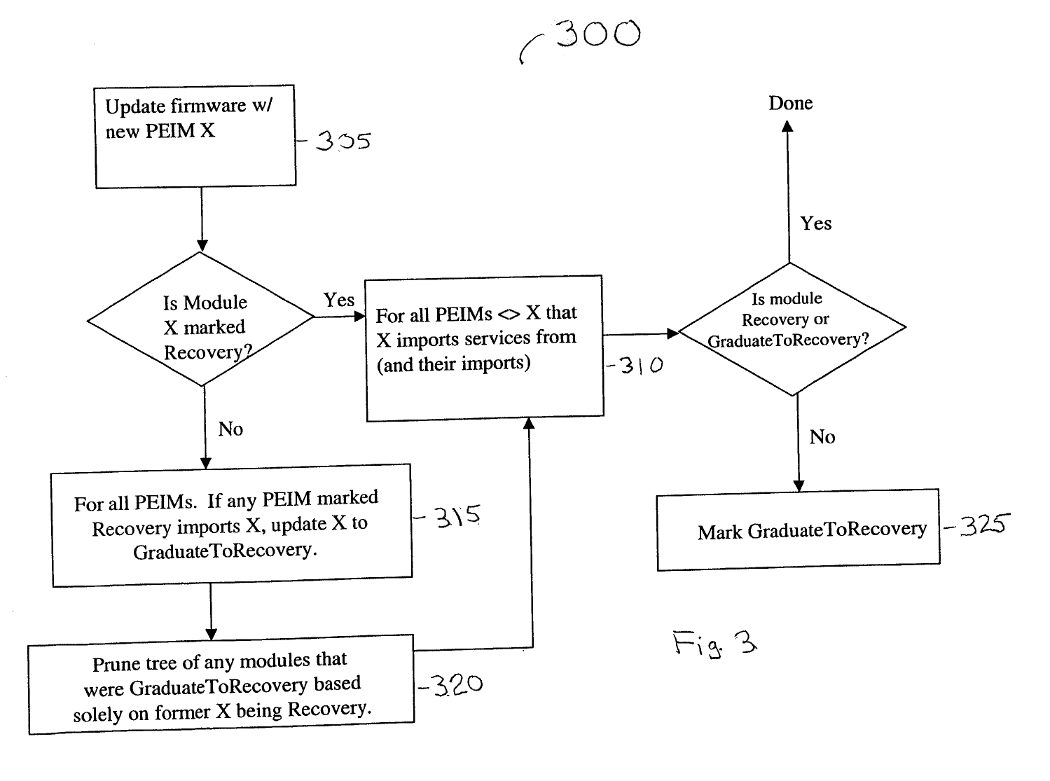

FIG. 3 is a process flow diagram in accordance with one embodiment of the present invention. Process 300, shown in FIG. 3 begins with operation 305 in which system firmware is updated with a new initialization module, IM_X. The firmware update utility makes an evaluation to determine if IM_X is designated as a RIM. If IM_X is designated as a RIM, then, at operation 310 all IMs that import services from IM_X are determined. These IMs communicate with IM_X, and provide services for the successful execution of IM_X. IM_X is then said to be dependent upon all IMs from which it imports services, and it is necessary to include all such IMs in the recovery block. Therefore all the IMs that provide services to IM_X are evaluated and if they are not RIMs, they are graduated to recovery and designated as RIMs at operation 325.

If upon evaluation it is determined that IM_X is not designated as a RIM, then at operation 315, all RIMs are evaluated to determine if they import services from IM_X (i.e., depend upon IM_X). If any RIMs are determined to depend on IM_X, then IM_X is graduated to recovery and designated as a RIM.

It is possible that the IM that IM_X is replacing, the former IM_X, was dependent upon one or more IMs and had caused such IMs to be graduated to recovery. At operation 320, RIMs that were graduated to recovery solely due to the former IM_X's dependence upon them will be pruned (i.e., removed from the recovery block). Pruning is done to help keep the recovery block as small as possible as it is expensive to protect the code. At this point the process proceeds from operation 210 as described above.

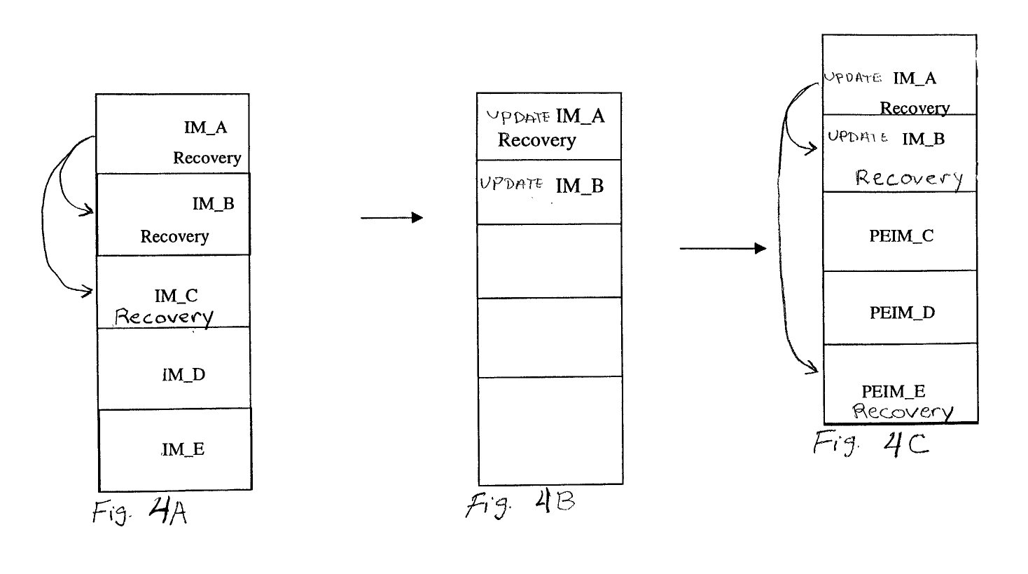

FIGS. 4A, 4B, and 4C depict a FV during an IM update and dynamic recovery designation process in accordance with the present invention.

FIG. 4A shows a FV containing IMs A through E. IM_A is marked as required for recovery. For example IM_A may initialize memory or may initialize rudimentary I/O services. IMs B and C are marked as recovery as well. The arrows indicate that IMs B and C provide services to IM_A (IM_A is dependent upon IM_B and IM_C). How they are marked, or tagged, for recovery is known in the art and is not important to this discussion. The FV store architecture preserves the IMs required for recovery by, for example, placing them in a fault-tolerant block. The IMs required for recovery may also be protected with hardware support such as baseboard hardware or on-chip silicon resources (e.g., flashpart). IMs D and E are not required for recovery and therefore are not tagged and not protected.

FIG. 4B depicts a firmware update in which IMs A and B will be replaced. As shown in FIG. 4B, the updated IM_A is marked as recovery, but the updated IM_B is not. For example, the component provider may simply provide the updated code and isn't concerned whether IM_B is recovery or not.

FIG. 4C depicts the firmware volume after the dynamic designation process of the present invention. As shown in FIG. 4C, the updated IM_A is designated as recovery. Although the updated IM_B was not designated by the provider as recovery, it has been graduated to recovery due to IM_A's dependence upon it. Where IM_C had been designated as recovery due to IM_A's dependence, IM_C has now been demoted from recovery to non-recovery status. This is due to the fact that the updated IM_A does not depend on IM_C. The sole reason IM_C had been designated as recovery was the dependence upon IM_C of the original IM_A. Likewise, IM_E, which had not been designated as recovery, may be dynamically graduated to recovery if the firmware update utility determines that a RIM (e.g., IM_A) depends upon IM_E.

This dynamic inclusion into (e.g., IM_E), and exclusion from (e.g., IM_C) the recovery set, helps to ensure that all IMs required for recovery are protected while helping to keep the number of recovery initialization modules to a minimum. This helps to ensure that a computing system in recovery mode can successfully execute all of the necessary IMs to effect a restoration of the firmware.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
adding an initiation module to a BIOS firmware of a computing system having an extensible firmware architecture, the BIOS firmware having a plurality of initiation modules with initiation modules required for the recovery of the computing system designated as recovery initiation modules and other initiation modules designated as non-recovery modules;
automatically evaluating the initiation module; and
designating the initiation module as a recovery initiation module if it is determined that the initiation module is required for recovery of the computing system.

2. The method of claim 1 further comprising:
designating the initiation module as a recovery initiation module if it is determined that a recovery initiation module depends upon the initiation module.

3. The method of claim 2 further comprising:
executing only recovery initiation modules in the event of a recovery restart.

4. The method of claim 2 wherein the initiation module is an updated recovery initiation module added to the BIOS firmware to replace an outdated recovery initiation module.

5. The method of claim 4 further comprising:
automatically evaluating all recovery initiation modules;
removing the recovery initiation module designation from all initiation modules designated as recovery initiation modules solely due to dependence thereon by the outdated recovery initiation module.

6. The method of claim 1 wherein the recovery initiation modules are rendered unalterable.

7. The method of claim 6 wherein the recovery initiation modules reside in a fault-tolerant firmware volume.

8. The method of claim 7 wherein the recovery initiation modules are contained in a 64 kilobyte block of code.

9. The method of claim 1 wherein recovery of the computing system is necessitated by an event selected from the group consisting of power failure, hardware failure, and security error.

10. A machine-readable medium that provides executable instructions which, when executed by a processor, cause the processor to perform a method, the method comprising:
adding an initiation module to a BIOS firmware of a computing system having an extensible firmware architecture, the BIOS firmware having a plurality of initiation modules with initiation modules required for the recovery of the computing system designated as recovery initiation modules and other initiation modules designated as non-recovery modules;
automatically evaluating the initiation module; and
designating the initiation module as a recovery initiation module if it is determined that the initiation module is required for recovery of the computing system.

11. The machine-readable medium of claim 10 wherein the method further comprises:
designating the initiation module as a recovery initiation module if it is determined that a recovery initiation module depends upon the initiation module.

12. The machine-readable medium of claim 10 wherein the method further comprises executing only recovery initiation modules in the event of a recovery restart.

13. The machine-readable medium of claim 11 wherein the initiation module is an updated recovery initiation module added to the BIOS firmware to replace an outdated recovery initiation module.

14. The machine-readable medium of claim 13 wherein the method further comprises:
automatically evaluating all recovery initiation modules;
removing the recovery initiation module designation from all initiation modules designated as recovery initiation modules solely due to dependence thereon by the outdated recovery initiation module.

15. The machine-readable medium of claim 10 wherein the recovery initiation modules are rendered unalterable.

16. The machine-readable medium of claim 15 wherein the recovery initiation modules reside in a fault-tolerant firmware volume.

17. The machine-readable medium of claim 16 wherein the recovery initiation modules are contained in a 64 kilobyte block of code.

18. The machine-readable medium of claim 10 wherein recovery of the computing system is necessitated by an event selected from the group consisting of power failure, hardware failure, and security error.

19. An apparatus comprising:
a computing system having an extensible firmware architecture, the BIOS firmware of the computing system having a plurality of initiation modules with initiation modules required for the recovery of the computing system designated as recovery initiation modules and other initiation modules designated as non-recovery modules; and
a firmware update utility to automatically evaluate the initiation module and designating the initiation module as a recovery initiation module if it is determined that the initiation module is required for recovery of the computing system.

20. The apparatus of claim 19 wherein the initiation module is designated as a recovery initiation module if it is determined that a recovery initiation module depends upon the initiation module.

21. The apparatus of claim 19 wherein only recovery initiation modules are executed in the event of a recovery restart.

22. The apparatus of claim 20 wherein the initiation module is an updated recovery initiation module added to the BIOS firmware to replace an outdated recovery initiation module.

23. The apparatus of claim 21 wherein all recovery initiation modules are automatically evaluated such that if the designation as a recovery initiation module is solely due to dependence thereon by the outdated recovery initiation module, the recovery initiation module designation is removed.

24. The apparatus of claim 19 wherein the recovery initiation modules are rendered unalterable.

25. The apparatus of claim 24 wherein the recovery initiation modules reside in a fault-tolerant firmware volume.

26. The apparatus of claim 25 wherein the recovery initiation modules are contained in a 64 kilobyte block of code.

27. The apparatus of claim 19 wherein recovery of the computing system is necessitated by an event selected from the group consisting of power failure, hardware failure, and security error.
